(19) United States
(12) Patent Application Publication
(10) Pub. No.: US 2006/0185951 A1
(43) Pub. Date: Aug. 24, 2006

(54) Hydraulic shock absorber system for a vehicle

(76) Inventor: Akira Tanaka, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/406,082

(22) Filed: Apr. 18, 2006

Related U.S. Application Data
(63) Continuation of application No. PCT/JP04/15357, filed on Oct. 18, 2004.

(30) Foreign Application Priority Data
Oct. 20, 2003 (JP) 2003-359804

(51) Int. Cl. F16F 9/34

(52) U.S. Cl. 188/322.13

(57) ABSTRACT

A hydraulic shock absorber system for a vehicle comprises a first shock absorber, a second shock absorber and an intermediate unit. The intermediate unit connects the first and second shock absorbers together. The intermediate unit comprises a plurality of throttle valves and a solenoid switch to adjust the damping characteristics of the system.

### CROSS-REFERENCE TO RELATED APPLICATIONS

This application is based upon and is a continuation of PCT Application No. PCT/04JP115357, filed Oct. 18, 2004, which is based upon Japanese Application No. 2003-359804, filed Oct. 20, 2003, each of which is hereby incorporated by reference in its entirety.

### BACKGROUND OF THE INVENTION

1. Field of the Invention

The present invention generally relates to a hydraulic shock absorber system for a vehicle that uses a pair of interrelated shock absorbers for vehicle suspension. More particularly, the present invention relates to a hydraulic shock absorber system that is adapted to relatively increase the damping force when each of the pair of shock absorbers is operating differently from the other.

2. Description of the Related Art

An example of a conventional hydraulic shock absorber system is disclosed in, for example, JP-A-Hei 8-132846. The hydraulic shock absorber system disclosed therein includes a first hydraulic shock absorber, a second hydraulic shock absorber and an intermediate unit that connects to the first and second hydraulic shock absorbers.

The intermediate unit is composed of a first pressure-regulating cylinder having a first oil chamber that communicates with an oil chamber of the first hydraulic shock absorber, a second pressure-regulating cylinder having a second oil chamber that communicates with an oil chamber of the second hydraulic shock absorber, a free piston inserted in both the pressure-regulating cylinders, and a high pressure gas chamber formed on the side opposite to the first and second oil chambers with the free piston therebetween. The intermediate unit also includes a stationary throttle and a movable throttle that are provided in a communication passage communicating between the first oil chamber and the second oil chamber. The first pressure-regulating cylinder and the second pressure-regulating cylinder, one of which is formed to be larger than the other in inner diameter, are arranged coaxially with each other. The free piston is formed such that changes in the volumes of the first and second oil chambers occurring as the free piston moves are at a fixed ratio at all times.

In such a system, when, for example, the first hydraulic shock absorber and the second hydraulic shock absorber operate in opposite directions which causes a pressure difference between the first oil chamber and the second oil chamber. In response, a damping force is generated in the intermediate unit by hydraulic fluid passing through at least one of the stationary throttle and the movable throttle. On the other hand, when the operating directions of the first and the second hydraulic shock absorbers are the same and the ratio of movements in the first and the second hydraulic shock absorbers are generally identical to the ratio of volume change in the first and the second oil chambers (which is always constant), no pressure difference occurs between the first and the second oil chambers. As a result, no hydraulic fluid passes through the two throttles. Thus, no damping force is generated in the intermediate unit.

Accordingly, in the conventional hydraulic shock absorber system as described above, by providing the first and second hydraulic shock absorbers on, for example, the left and right sides of the vehicle body, damping force is generated by the first and second hydraulic shock absorbers and the intermediate unit at the time of rolling. Further, in the hydraulic shock absorber system, damping force is generated only in the first and second hydraulic shock absorbers at times other than during the rolling, such as during bouncing. That is, in the hydraulic shock absorber system, a relatively large damping force is generated during cornering, whereas the damping force becomes relatively small during the bouncing or the like.

The stationary throttle is composed of check valves including valve members. The valve members typically comprise disc-shaped leaf springs. Usually, there are two kinds of check valves, one permitting the flow of hydraulic fluid from the first oil chamber to the second oil chamber, and the other permitting the flow of hydraulic fluid from the second oil chamber to the first oil chamber. The movable throttle also comprises a spool valve interposed between the first oil chamber and the second oil chamber so as to be in parallel with the stationary throttle.

The spool valve is formed such that a spool is pressed from one side by the resultant force of the pressing force exerted by a solenoid and the elastic force of a first compression coil spring and the spool is pressed from the other side by the elastic force of a second compression coil spring. Further, the spool valve is constructed such that by switching between the energized and non-energized states of the solenoid, the spool moves in the axial direction, thereby opening and closing a hydraulic fluid passage.

By varying the amount of current passed through the solenoid, the spool moves to a position where the resultant force of the force exerted by the solenoid, the elastic force of the first compression coil spring and the elastic force of the second compression coil spring are in balance with each other, thereby making it possible to adjust the sectional area of the passage through which the hydraulic fluid flows. That is, upon energization, the spool moves until it reaches a position where the thrust of the solenoid and the reaction force of an equalizer spring are in balance with each other.

Accordingly, in the conventional hydraulic shock absorber system as described above, the resistance encountered when the hydraulic fluid flows is increased/decreased by varying the amount of current passed through the solenoid and varying the passage sectional area of the movable throttle, whereby the magnitude of the damping force, which is generated with respect to the difference in piston speed between the first hydraulic shock absorber and the second hydraulic shock absorber, can be adjusted from the outside.

### SUMMARY OF THE INVENTION

Thus, one aspect of the present invention involves a hydraulic shock absorber system for a vehicle. The system comprises an intermediate unit that fluidly connects a first shock absorber and a second shock absorber. The intermediate unit comprises a smaller-diameter cylinder body and a larger-diameter cylinder body. The smaller-diameter cylinder body comprises a bore and the larger-diameter cylinder body comprises a bore. The smaller-diameter cylinder body and the larger-diameter cylinder body are connected to each other with the smaller-diameter cylinder body bore and the larger-diameter cylinder body bore being generally coaxial. A smaller-diameter piston is positioned within the smaller-diameter cylinder body bore and a larger-diameter piston is positioned within the larger-diameter cylinder body bore. The smaller-diameter piston and the larger-diameter piston are integrally formed to define a free piston. A first oil chamber is defined to a first side of the smaller-diameter piston. A second oil chamber is defined between the smaller-diameter piston and the larger-diameter piston. A high pressure gas chamber is defined to a second side of the larger-diameter piston. The first oil chamber communicates with an oil chamber of the first shock absorber and the second oil chamber communicates with an oil chamber of the second shock absorber. A passage connects the first oil chamber and the second oil chamber. The passage extends through the smaller-diameter piston. A throttle is positioned to affect flow through the passage. A bypass passage also extends between the first oil chamber and the second oil chamber. The bypass passage is defined within the smaller-diameter cylinder body. An on/off valve and a throttle are provided in series along the bypass passage. The on/off valve is opened and closed by a solenoid. The solenoid is connected to the smaller-diameter cylinder body at a solenoid mounting portion. A hydraulic oil pipe connects the first oil chamber and the second oil chamber to the first and second shock absorbers. The hydraulic oil pipe is connected to the smaller-diameter cylinder body at a hydraulic oil pipe mounting portion. The smaller-diameter cylinder body comprises a mounting boss adapted to secure the unit on a vehicle frame side.

### BRIEF DESCRIPTION OF THE DRAWINGS

These and other features, aspects and advantages of the present invention will now be described with reference to the drawings of a preferred embodiment, which embodiment is intended to illustrate and not to limit the invention. The figures comprise nine drawings.

FIG. 1 is a view showing a hydraulic shock absorber system according to the present invention.

FIG. 2 is a front view of an intermediate unit.

FIG. 3 is a sectional view taken along the line III-III of FIG. 4.

FIG. 4 is a partially sectioned side view of the intermediate unit.

FIG. 5 is an enlarged sectional view showing a valve seat portion of an on/off valve.

FIG. 6 is an enlarged sectional view showing passages through a piston.

FIG. 7 is an enlarged plan view showing a part of a sheet-like valve member.

FIG. 8 is a graph showing damping force characteristics of a configuration of the system.

FIG. 9 is a perspective view showing an example of mounting to an automobile.

### DETAILED DESCRIPTION OF THE PREFERRED EMBODIMENT

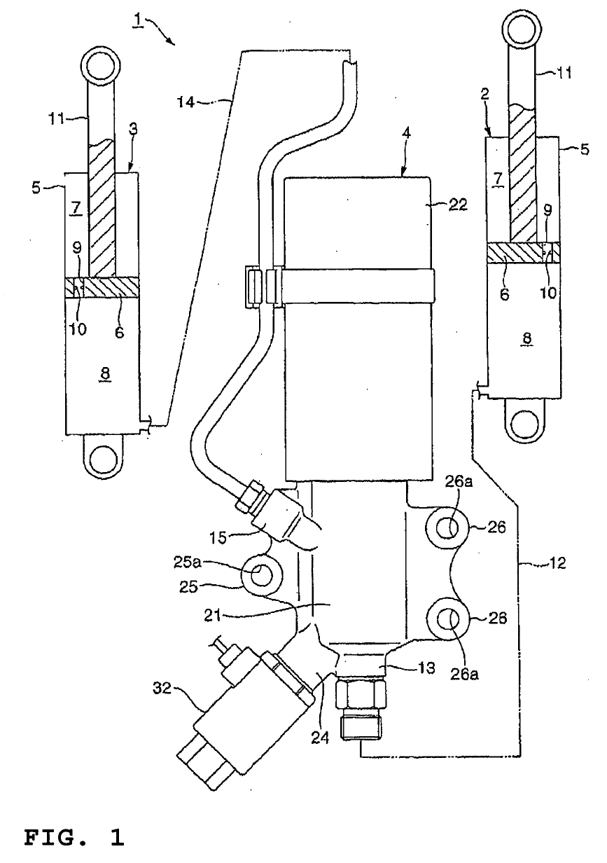

Hereinafter, an embodiment of a hydraulic shock absorber system for a vehicle that has been arranged and configured in accordance with certain features, aspects and advantages of the present invention will be described in detail with reference to FIGS. 1 through 9. The present invention is applicable to passenger vehicles such as an automobile; however, certain features, aspects and advantages of the present invention may find utility in other applications.

With reference to FIGS. 1 through 9, reference numeral 1 denotes a hydraulic shock absorber system for front wheels of a vehicle. The hydraulic shock absorber system 1 comprises a first hydraulic shock absorber 2, a second hydraulic shock absorber 3, and an intermediate unit 4 connected to the hydraulic shock absorbers 2, 3.

Each of the first and second hydraulic shock absorbers 2, 3 comprises an upper oil chamber 7 and a lower oil chamber 8 defined inside a cylinder main body 5 with a piston 6. The inner portion of each chamber 7, 8 is filled with a hydraulic fluid. A communication passage 9 extends through each piston 6 such that the upper oil chamber 7 and the lower oil chamber 8 communicate with each other. Preferably, a throttle 10 or other suitable flow restrictor is disposed within the passage 9.

The upper end portion of a piston rod 11 of each of the first and second hydraulic shock absorbers 2, 3 can be mounted to a vehicle body (not shown) of an automobile. In such configurations, the lower end portion of the cylinder body 5 of each of the first and second hydraulic shock absorbers 2, 3 can be pivotally supported on a portion of an associated vehicle, such as a front wheel suspension link (not shown), that moves vertically with respect to the vehicle body. That is, the first and second hydraulic shock absorbers 2 and 3 generally are interposed between the vehicle body and the front wheel. In this embodiment, the first hydraulic shock absorber 2 is arranged on the right side of the vehicle body, and the second hydraulic shock absorber 3 is arranged on the left side of the vehicle body. Of the first and second hydraulic shock absorbers 2 and 3, a hydraulic oil pipe 12 connects the lower oil chamber 8 of the hydraulic shock absorber 2 located on the right side (also right side in FIG. 1) of the vehicle body to a first hydraulic oil pipe mounting portion 13 of the intermediate unit 4 that will be described later. A hydraulic oil pipe 14 connects the lower oil chamber 8 of the other hydraulic shock absorber 3 to a second hydraulic oil pipe mounting portion 15 of the intermediate unit 4.

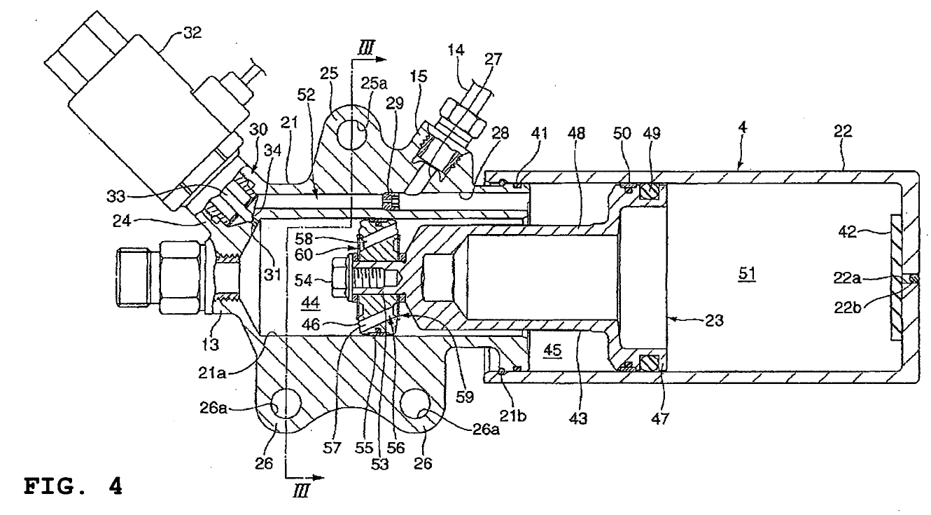

With reference to FIG. 4, the intermediate unit 4 comprises a smaller-diameter cylinder body 21 to which the first and second hydraulic shock absorbers 2 and 3 are connected. A larger-diameter cylinder body 22 is mounted to one end portion of the smaller-diameter cylinder body 21. A free piston 23 fits in the inner portions of the two cylinder bodies 21, 22.

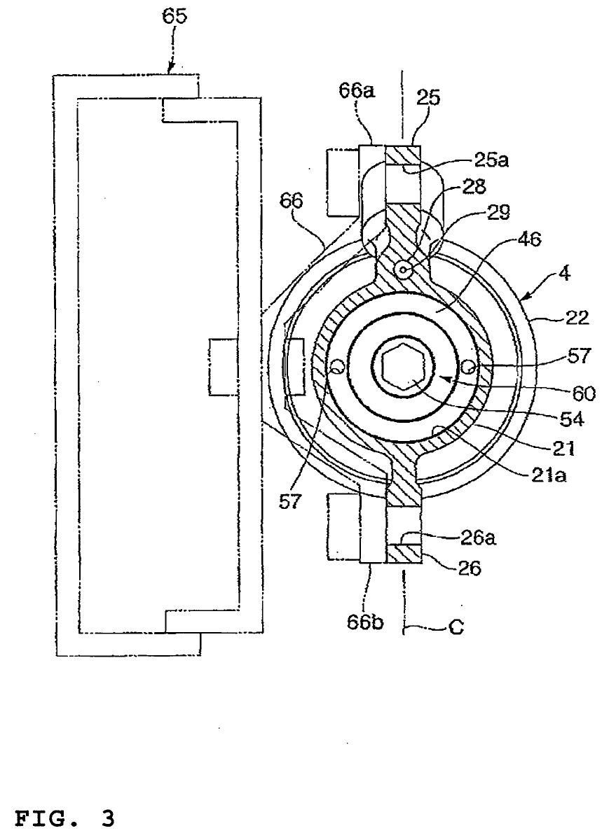

The smaller-diameter cylinder body 21 can be formed in any suitable technique, such as by casting, for instance, and can be subjected to machining, such as grinding or drilling after being formed so that a cylinder bore 21a and other respective portions thereof that will be described later can be accurately formed. Although not shown, a casing mold for forming the smaller-diameter cylinder body 21 can comprise first and second molds that part in the radial direction of the smaller-diameter cylinder body 21. The molds also can comprise a core that rough forms the cylinder bore 21a. The first mold and the second mold can be formed such that the parting plane thereof is located at a position indicated by the alternate long and short dash line C in FIG. 3. In other words, the first mold and the second mold are joined along a plane such as that indicated by the line C in FIG. 3. After casting, the first and second mold can be separated along this plane to remove the intermediate unit for finishing operations. Other configurations also are possible.

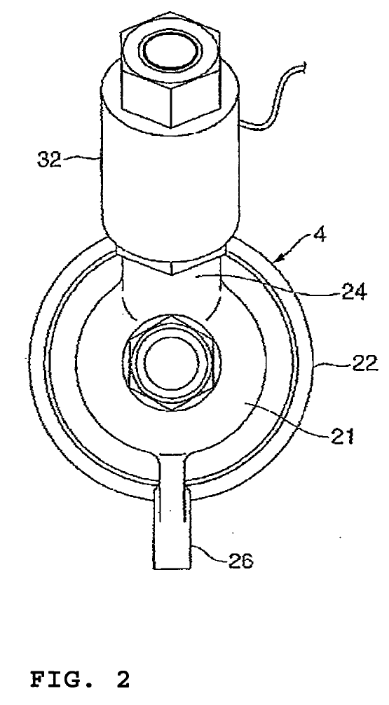

As shown in FIGS. 2-4, in some embodiments of the smaller-diameter cylinder body 21, the first and second hydraulic oil pipe mounting portions 13, 15, a solenoid mounting portion 24, mounting bosses 25, 26, and the like can be positioned at portions located on the mold parting plane. The cylinder bore 21a preferably is open at one end portion (the right-hand side end portion in FIG. 4) of the smaller-diameter cylinder body 21 and the cylinder bore 21a preferably communicates with the inner portion of the larger-diameter cylinder body 22.

The first hydraulic oil pipe mounting portion 13 can be formed in a generally cylindrical configuration and can protrude from the end portion of the smaller-diameter cylinder body 21 on the side opposite to the larger-diameter cylinder body 22 so as to be located generally coaxially with the cylinder bore 21a. The inner portion of the first hydraulic oil pipe mounting portion 13 communicates with the inside of the cylinder bore 21a.

The second hydraulic oil pipe mounting portion 15 can be formed in a generally cylindrical configuration and can protrude generally diagonally from the outer portion of the larger-diameter cylinder body 22-side end portion of the smaller-diameter cylinder body 21. The slanting direction of the second hydraulic oil pipe mounting portion 15 preferably is such that it is located progressively toward the larger-cylinder body 22 side as it extends outwards in the radial direction of the smaller-diameter cylinder body 21. In other words, the second hydraulic oil pipe mounting portion 15 is inclined with the base being closer to the first hydraulic oil pipe mounting portion 13 that the distal end of the second hydraulic oil pipe mounting portion 15. As shown in FIG. 4, the inner portion of the second hydraulic oil pipe mounting portion 15 communicates with a second hydraulic fluid passage 28, which will be described later, via a first hydraulic fluid passage 27.

The second hydraulic fluid passage 28 is open at one face of the smaller-diameter cylinder body 21 on the larger-diameter cylinder body 22 side, and the second hydraulic fluid passage 28 extends through the inside of the smaller-diameter cylinder body 21 from this opening toward the other end side along the axial direction of the cylinder bore 21a. A first throttle 29 can be provided within the second hydraulic fluid passage 28. Preferably, the first throttle 29 is positioned about midway through the second hydraulic fluid passage 28. Even more preferably, the first throttle 29 is positioned about midway through the second hydraulic fluid passage 28 on the other end relative to the connecting portion with the first hydraulic fluid passage 27. The first throttle 29 can be mounted in any suitable manner. In one configuration, the first throttle 29 is threaded into the second hydraulic fluid passage 28 after being inserted through the opening formed at the larger-diameter cylinder body end. Further, the end portion of the second hydraulic fluid passage 28 on the other end communicates with the inside of the cylinder bore 21a via an on/off valve 30 and a second throttle 31.

As shown in FIGS. 4 and 5, the on/off valve 30 is constructed such that the solenoid mounting portion 24 formed in the smaller-diameter cylinder body 21 functions as a valve body. The on/off valve 30 preferably is driven by a solenoid 32 mounted to the solenoid mounting portion 24. The mounting portion 24 can be formed as a bottomed cylinder (i.e., a cylinder with an end wall) and provided so as to diagonally protrude from the end portion of the smaller-diameter cylinder body 21 on the side opposite to the larger-diameter cylinder body 22. The slanting direction of the solenoid mounting portion 24 is such that its distance from the larger-diameter cylinder body 22 increases gradually as it extends outwards in the radial direction of the smaller-diameter cylinder body 21. Thus, the second hydraulic oil pipe mounting portion 15 and the solenoid mounting portion 24 incline in generally opposing axial directions. Further, at the bottom portion of the mounting portion 24, there is formed a valve seat 34 on which a valve member 33 of the on/off valve 30 is seated, and one end of the second hydraulic fluid passage 28 is open.

As shown in FIG. 5, the valve member is formed in a bar-like configuration with a generally conical distal end portion. The valve member 33 preferably is supported on the solenoid 32 while being located generally coaxially with the mounting portion 24. The solenoid 32 can be connected to a damping force changing switch (not shown). Through operation of the damping force changing switch, the solenoid 32 changes between a closed state in which the valve member 33 is seated on the valve seat 34 as shown in FIG. 5 and an open state in which the valve member 33 is separated from the valve seat 34 as indicated by the two-dot chain line in FIG. 5.

The solenoid 32 preferably comprises a built-in return spring (not shown) that urges the valve member 33 open. When energized, the solenoid 32 preferably closes the valve member 33 against the elastic force of the return spring. The valve seat 34 can be defined by a circular recess 35 provided at the bottom of the axial center portion of the mounting portion 24. One end of the second throttle 31 can be open at the axial center portion of the circular recess 35. The second throttle 31 according to this embodiment is formed by a smaller-diameter hole bored in the bottom wall of the mounting portion 24. Other configurations also are possible.

As shown in FIG. 3, the mounting bosses 25 and 26 can be provided at three radial positions (i.e., at one upper position and at two lower positions in FIG. 3). Preferably, the locations are on the parting plane of the smaller-diameter cylinder body 21. More preferably, the locations have bolt insertion holes 25a and 26a formed therein, respectively.

The larger-diameter cylinder body 22 can be formed into a bottomed cylinder. In some configurations, a cap can be threaded into a generally cylindrical opening to define a bottomed cylinder. The larger-diameter cylinder body 22 is brought into fitting engagement with one end portion of the smaller-diameter cylinder body 21 while being located coaxially with the cylinder bore 21a. Preferably, the larger-diameter cylinder body 22 is fixed in place relative to the smaller-diameter cylinder body with a circlip 21b. Other suitable constructions also can be used.

An O-ring 41 can be interposed in the fitting engagement portion so as to achieve substantial fluid tightness. The larger-diameter cylinder body 22 according to this embodiment has a gas injection hole 22a bored at its bottom portion, and a sheet 42 attached to the bottom portion. In one configuration, the sheet 42 is formed of a rubber material. The sheet 42 preferably reduces the likelihood of gas leakage. After gas injection, the sheet 42 is urged over the gas injection hole 22a by the resultant gas pressure. Preferably, a steel ball 22b or other suitable component is press-fit into the gas injection hole 22a after the gas has been injected.

The free piston 23 preferably comprises a larger-diameter piston 43 formed in the shape of a bottomed cylinder, and a smaller-diameter piston 46. The smaller-diameter piston 46 can be mounted onto a portion (the left-hand side end portion in FIG. 4) of the larger-diameter piston 43 and serves to divide the inside of the smaller-diameter cylinder body 21 into a first oil chamber 44 and a second oil chamber 45.

In the larger-diameter piston 43, a piston body 47 located on the opening-side end portion and a bottomed cylindrical portion 48 located on the other end side preferably are integrally formed. The piston body 47 can be formed so as to be larger in outer diameter than the bottomed cylindrical portion 48, and an O-ring 49 and a seal ring 50 can be fitted onto the outer peripheral portion thereof. The piston body 47 is movably fitted inside the larger-diameter cylinder body 22. The inner portion of the larger-diameter cylinder body 22 according to this embodiment is divided into a high pressure gas chamber 51 and the second oil chamber 45 by means of the larger-diameter piston 43. The high pressure gas chamber 51 is located on the bottom portion side of the larger-diameter cylinder body 22 and contains high-pressure N2 gas. Other configurations are possible.

The second oil chamber 45 is filled with a hydraulic fluid. The second oil chamber 45 communicates with the second hydraulic oil pipe mounting portion 15 via the second hydraulic fluid passage 28, which is open at one end portion of the smaller-diameter cylinder body 21, and the first hydraulic fluid passage 27 connected to a midway portion of the second hydraulic fluid passage 28. The other end side of the second hydraulic fluid passage 28, to which the first and second throttles 29 and 31 and the on/off valve 30 are provided, communicates with the first oil chamber 44. In this embodiment, a bypass passage 52 comprises a passage formed by the second hydraulic fluid passage 28, the first and second throttles 29, 31, and the on/off valve 30. In the bypass passage 52, the first throttle 29 and the second throttle 31 are provided in series.

The bottomed generally cylindrical portion 48 of the larger-diameter piston 43 is formed such that its outer diameter is smaller than the inner diameter of the smaller-diameter cylinder body 21. The end portion of the bottomed cylindrical portion 48 on the side opposite to the piston body 47 is inserted into the smaller-diameter cylinder body 21. The second oil chamber 45 thus communicates with the inside of the smaller-diameter cylinder body 21. Further, a supporting column 53 that carries the smaller-diameter piston 46 protrudes from the end portion of the bottom cylindrical portion 48 on the side opposite to the piston body 47.

The smaller-diameter piston 46 is fixed onto the supporting column 53 in any suitable manner. In the illustrated configuration, the smaller-diameter piston is secured with a bolt 54, and is brought into a sliding fit with the smaller-diameter cylinder body 21. The first oil chamber 44 partitioned from the second oil chamber 45 by the smaller-diameter piston 46 is filled with a hydraulic fluid and communicates with the first hydraulic oil pipe mounting portion 13.

The smaller-diameter piston 46 preferably comprises a disc-like configuration with a seal ring 55 that is positioned on its outer peripheral portion. The smaller-diameter piston 46 and the larger-diameter piston 43 preferably are formed such that the effective sectional area of the first oil chamber 44 and the effective sectional area of the second oil chamber 45 are substantially the same. That is, the intermediate unit 4 is constructed such that a change in the volume of the smaller-diameter cylinder body 21 and that of the larger-diameter cylinder body 22 are at a fixed ratio at all times. In some configurations, the movement of the free piston 23 results in generally equal changes of volume in the first and second oil chambers 44, 45.

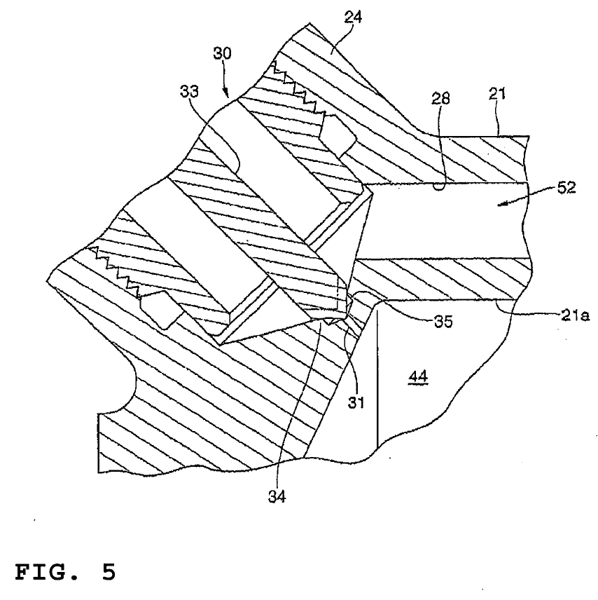

Further, the smaller-diameter piston 46 is provided with a third throttle 56. The third throttle extends between the first oil chamber 44 and the second oil chamber 45 such that the two chambers 44, 45 can be in fluid communication with each other. As shown in FIGS. 4 and 6, the third throttle 56 comprises a first communication passage 57 and a second communication passage 58 that extend through the smaller-diameter piston 46. The third throttle 56 also comprises a first check valve 59 and a second check valve 60 that are positioned along the communication passages 57, 58, respectively.

In the illustrated configurations, the first communication passage 57 and the second communication passage 58 are each provided in two circumferential locations of the smaller-diameter piston 46. Other configurations are possible. As shown in FIG. 6, one end of each of the passages 57, 58 is open at an outer radial end portion of the smaller-diameter piston 46, and the other end thereof is open in annular recesses 61 and 62 formed in opposite end faces of the smaller-diameter piston 46, respectively. The first communication passage 57 and the second communication passage 58 are depicted as being located on the same plane in FIG. 4, and the first communication passages 57 and the second communication passages 58 are depicted as being located at positions close to each other in FIG. 6. In actuality, however, the first communication passages 57 and the second communication passages 58 are formed at positions shifted by 90° from each other in the circumferential direction of the smaller-diameter piston 46.

One end of the first communication passage 57 is open at an outer radial end portion of the smaller-diameter piston 46 located on the first oil chamber 44 side, and the other end thereof is open in the annular recess 61 located on the second oil chamber 45 side. One end of the second communication passage 58 is open at an outer radial end portion of the smaller-diameter piston 46 located on the second oil chamber 45 side, and the other end thereof is open in the annular recess 62 located on the first oil chamber 44 side.

As shown in FIG. 6, the first and second check valves 59, 60 are each provided with valve members 63 each comprising three leaf springs. Other configurations are possible. The check valves 59, 60 open and close the annular recesses 61, 62, respectively, by means of the valve members 63. The three valve members 63 of the respective check valves are formed in a disc-like configuration so as to be capable of blocking the annular recesses 61, 62, and are overlapped together while being located coaxially with each other and attached onto the supporting column 53 of the larger-diameter piston 43 together with the smaller-diameter piston 46. One or more washers 54a can be used to help secure the valve members 63 in position. In the illustrated embodiment, the first and second check valves 59, 60 are fastened onto the larger-diameter piston 43 by the bolt 54 while being sandwiched between the smaller-diameter piston 46 and the washers 54a. Other configurations are possible.

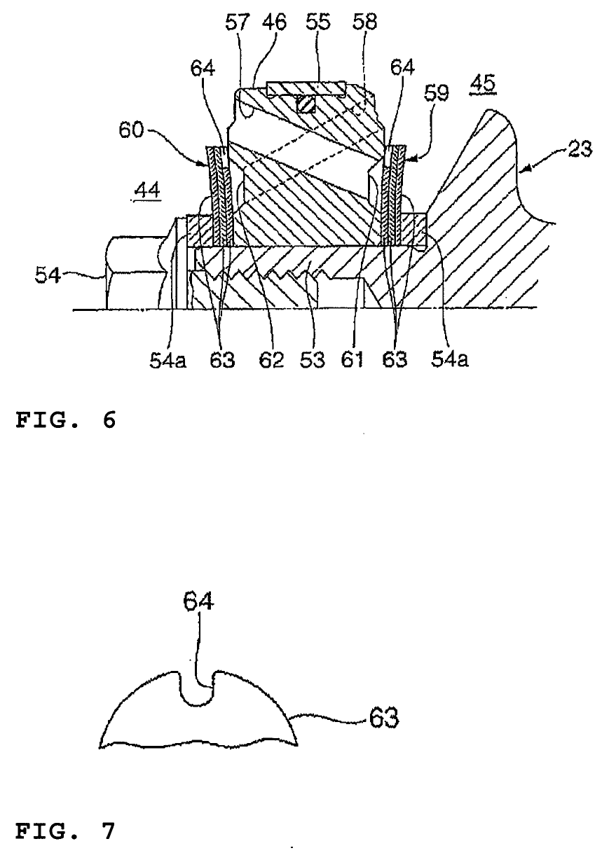

The first check valve 59 is mounted to generally block the annular recess 61 (first communication passage 57), which is located on the second oil chamber 45 side, by an initial set load. The second check valve 60 is mounted to generally block the annular recess 62 (second communication passage 58), which is located on the first oil chamber 44 side, by an initial set load. Further, as shown in FIGS. 6 and 7, of the three valve members 63 of the respective check valves, the valve members 63 in contact with the opening portions of the annular recesses 61 and 62 each have a cutout 64 formed in at least one location of its outer peripheral portion. The cutouts 64 help establish communication between the annular recesses 61, 62 and the first and second oil chambers 44, 45, respectively. The cutout 64 constitutes a part of the third throttle 56. By changing the opening width (width with respect to the circumferential direction of the valve member 63) of the cutout 64, the damping force characteristics prior to opening of the first and second check valves 59 and 60 can be changed. In other words, small cutouts 64 can allow some volume of flow, which volume can allow the unit to accommodate small changes, such as due to road vibration.

As shown in FIG. 3, the intermediate unit 4 constructed as described above is mounted to a supporting stay 66 of a vehicle body frame 65. The illustrated supporting stay 66 is formed in a V-shaped configuration as seen in the front view of FIG. 3, and has mounting seats 66a, 66b formed at its upper and lower end portions, respectively. Of the mounting seats 66a, 66b, the mounting boss 25 of the intermediate unit 4 is fixed to the upper mounting seat 66a, and the other mounting bosses 26 of the intermediate unit 4 are mounted to the lower mounting seat 66b. That is, in this embodiment, the intermediate unit 4 is mounted to the supporting stay 66 such that the axes of the smaller-diameter cylinder body 21 and of the larger-diameter cylinder body 22 become substantially horizontal and the mounting bosses 25 and 26 extend upward and downward, respectively, from the smaller-diameter cylinder body 21.

In the above-described hydraulic shock absorber system 1 for a vehicle equipped with the intermediate unit 4, when, for example, the right and left hydraulic shock absorbers 2 and 3 are actuated in the same direction by the same amount, the hydraulic fluid passes through the throttle 10 of each of the hydraulic shock absorbers 2 and 3, whereby the hydraulic fluid flows between the upper and lower oil chambers. Further, at this time, the hydraulic fluid enters and exits the intermediate unit 4 in an amount corresponding to an increase/decrease in the volume of the piston rod 11 in the cylinder body 5, causing the free piston 23 to move. For example, when the hydraulic fluid flows out from each of the right and left hydraulic chambers 2 and 3, the hydraulic fluid flows into the intermediate unit 4 from each of the first and second hydraulic oil pipe mounting portions 13 and 15, causing the free piston 23 to move rightward in FIG. 4. The operation of the free piston 23 at this time is the same irrespective of whether the on/off valve 30 is in the open or closed state.

When a change in the volume of the first oil chamber 44 and a change in the volume of the second oil chamber 45 are equal to each other as described above, in other words, when the amount of hydraulic fluid entering and exiting the first oil chamber 44 and the amount of hydraulic fluid entering and exiting the second oil chamber 45 are in balance with each other, the hydraulic fluid does not pass through the first to third throttles 29, 31, and 56. That is, when the phases of the operations of the right and left hydraulic shock absorbers 2 and 3 are the same, the damping force is generated solely by the hydraulic fluid passing through the throttle 10 in each of the hydraulic shock absorbers 2 and 3.

On the other hand, when the right and left hydraulic shock absorbers 2 and 3 actuate in the opposite directions, the amount of hydraulic fluid entering and exiting the first oil chamber 44 of the intermediate unit 4 and the amount of hydraulic fluid entering and exiting the second oil chamber 45 are not in balance with each other. A difference occurs between the hydraulic pressure in the first oil chamber 44 and the hydraulic pressure in the second oil chamber 45. For example, when the hydraulic shock absorber 2 on the right side of the vehicle body undergoes compression and the hydraulic shock absorber 3 on the left side of the vehicle body undergoes expansion, the hydraulic pressure of the first oil chamber 44 becomes higher than the hydraulic pressure of the second oil chamber 45. Now, first, the operation when the on/off valve 30 is closed will be described.

In the state where the on/off valve 30 is closed, the hydraulic fluid cannot enter or exit the bypass passage 52 having the second hydraulic fluid passage 28, so the first throttle 29 and the second throttle 31 cannot function. When, in the state where the on/off valve 30 is closed, the right and left shock absorbers 2 and 3 actuate in opposite directions, and a difference occurs between the hydraulic pressure of the first oil chamber 44 and the hydraulic pressure of the second oil chamber 45, a hydraulic pressure corresponding to the pressure difference between the two oil chambers 44, 45 is exerted on the third throttle 56 of the smaller-diameter piston 46.

In this case, the hydraulic pressure is exerted on the first check valve 59, which opens and closes the first communication passage 57 of the smaller-diameter piston 46, from the first oil chamber 44 side via the first communication passage 57 so as to force the first check valve 59 to open. At this time, the degree of pressure increase is adjusted by a small amount of hydraulic fluid passing through the cutout 64 provided in the first check valve 59, and the first check valve 59 opens when the hydraulic pressure exceeds the initial set load of the first check valve 59. The opening of the first check valve 59 allows the hydraulic fluid to pass through the third throttle 56 of the smaller-diameter piston 46.

By the hydraulic fluid thus passing through the third throttle 56, a damping force is generated not only in the throttle 10 of each of the two hydraulic shock absorbers 2, 3 but also in the intermediate unit 4. In the case where the slanting direction of the vehicle body is opposite to the direction described above, a damping force is generated when the second check valve 60 for opening and closing the second communication passage 58 opens and thus the hydraulic fluid flows from the second oil chamber 45 into the first oil chamber 44 through the second communication passage 58.

In the state where the on/off valve 30 is open, the first oil chamber 44 and the second oil chamber 45 are communicated with each other by the bypass passage 52 (composed of the second hydraulic fluid passage 28, the first and second throttles 29, 31, and the on/off valve 30). In this state, when, for example, the hydraulic pressure in the first oil chamber 44 becomes higher than the hydraulic pressure in the second oil chamber 45, the hydraulic fluid passes through the first to third throttles 29, 31, 56, thus flowing from the first oil chamber 44 into the second oil chamber 45.

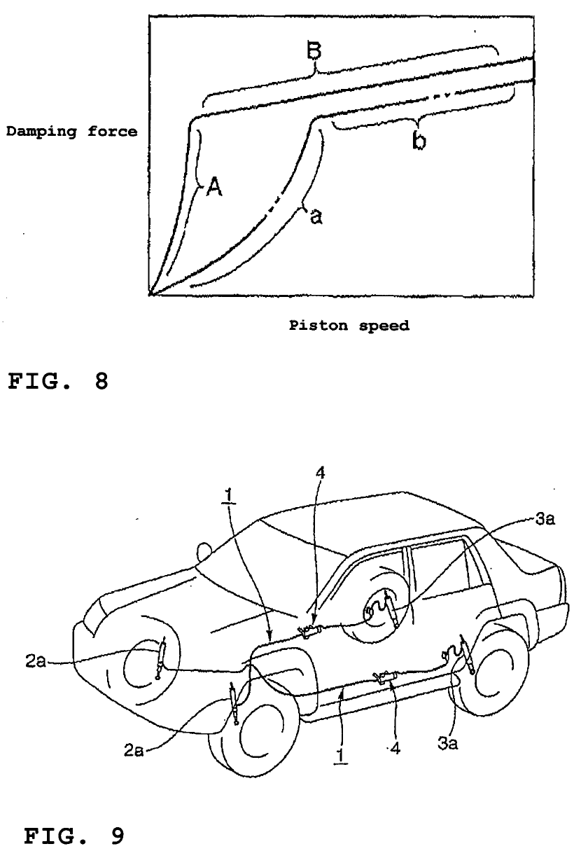

That is, in the state where the on/off valve 30 is open, the hydraulic fluid passes through the throttles provided at three locations. Accordingly, provided that the magnitude of the differential pressure between the two oil chambers is the same, the generated damping force becomes small as compared with the case where the on/off valve 30 is closed. FIG. 8 shows changes in the damping force and differential pressure that occur in the intermediate unit 4. In FIG. 8, the vertical axis represents damping force, and the horizontal axis represents piston speed. The word “piston speed” as used herein refers to the speed of the other piston 6 relative to the speed of the piston 6 of one of the right and left hydraulic shock absorbers 2, 3. The value of the piston speed becomes zero when the two pistons 6 move in the same direction at the same speed. Further, in FIG. 8, a change in damping force when the on/off valve 30 is closed is indicated by the solid line, and a change in damping force when the on/off valve 30 is opened is indicated by the two-dot chain line.

As indicated by the solid line in FIG. 8, in the region indicated by symbol A with the on/off valve 30 being closed, the amount of hydraulic fluid passing through the cutout 64 of the third throttle 56 increases in accordance with an increase in piston speed, causing a rapid increase in damping force. Then, when the piston speed further increases, and the hydraulic pressure exceeds the initial set load of the check valve, the first check valve 59 or the second check valve 60 opens so that a transition to the region indicated by symbol B and exhibiting more gentle damping characteristics takes place, whereby the damping force increases substantially in proportion to an increase in the elastic force of the leaf springs (valve members 63).

On the other hand, as indicated by the two-dot chain line in FIG. 8, in the region indicated by symbol (a) with the on/off valve 30 being open, as the piston speed increases, the amount of hydraulic fluid passing through the cutout 64 and the first and second throttles 29 and 31 increases, and the rate of increase in damping force at this time is small as compared with the case where the on/off valve 30 is closed. Then, when the piston speed further increases, and, in the same manner as described above, the first check valve 59 or the second check valve 60 opens to cause a transition to the region indicated by symbol (b), the damping force increases substantially in proportion to an increase in the elastic force of the leaf springs (valve members 63) as in the case where the on/off valve 30 is closed.

Accordingly, in the hydraulic shock absorber system 1 for a vehicle according to this embodiment, the first and second throttles 29, 31, and the on/off valve 30 are provided in the bypass passage 52 extending between the first oil chamber 44 and the second oil chamber 45 of the intermediate unit 4, whereby the magnitude of the damping force generated in the intermediate unit 4 can be increased/decreased by switching between the open and closed states of the on/off valve 30. That is, with the hydraulic shock absorber system 1 for a vehicle as described above, the damping force can be changed by means of a simple structure as compared with the case where the damping force is adjusted by using a spool valve, thereby making it possible to achieve a reduction in manufacturing cost.

Further, in the hydraulic shock absorber system 1 for a vehicle as described above, projecting portions such as the solenoid mounting portion 24, the hydraulic oil pipe mounting portions 13 and 15, and the bosses 25 and 25 for mounting on the vehicle body frame are provided to the smaller-diameter cylinder body 21 by casting. Therefore, the smaller-diameter cylinder body 21 can be easily formed as compared with the case where these components are formed as separate components, such as when they are welded onto the smaller-diameter cylinder body 21.

In addition, the projecting portions are arranged on the parting plane of the casting for the smaller-diameter cylinder body 21, thereby achieving good castability of the smaller-diameter cylinder body 21 as compared with the case where the plurality of projecting portions are arranged so as to be, for example, radially scattered in the circumferential direction of the smaller-diameter cylinder body 21. Moreover, this construction allows the smaller-diameter cylinder body 21 to be formed compact in the parting direction (the lateral direction in FIG. 3) of the casting mold. Therefore, by mounting the intermediate unit 4 to the vehicle body frame 65 in the state where the mounting bosses 25 and 26 extend upwards and downwards, respectively, and the axes of the smaller-diameter cylinder body 21 and larger-diameter cylinder body 22 are oriented in the longitudinal direction of the vehicle body, the space occupied by the intermediate unit 4 is reduced with respect to the vehicle width direction. Therefore, the hydraulic shock absorber system 1 for a vehicle according to this embodiment enables a further reduction in the size and cost of the smaller-diameter cylinder body 21 while being equipped with the mechanism for adjusting the magnitude of the damping force.

Further, in the hydraulic shock absorber system 1 for a vehicle according to this embodiment, the first throttle 29 and the second throttle 31 are provided in series in the bypass passage 52. When the hydraulic fluid flows in the bypass passage 52, the hydraulic fluid repeatedly undergoes expansion and compression, whereby the pressure loss becomes large as compared with the case where only one throttle is provided. Accordingly, with the hydraulic shock absorber system 1 for a vehicle according to this embodiment, a damping force equivalent to that attained when a single throttle with a relatively small bore diameter is used can be generated while using the first throttles 29 and 31 whose bore diameters are relatively large. Since the manufacturing cost generally becomes higher as the bore diameter becomes smaller, a further reduction in cost can be achieved by adopting the construction according to this embodiment. Moreover, a damping force of a requisite magnitude can be generated using throttles whose bore diameters are large enough to reduce the likelihood of clogging with fine foreign matter contained in the hydraulic fluid, whereby a hydraulic shock absorber system with high reliability can be manufactured.

In addition, in the intermediate unit 4 of the hydraulic shock absorber system 1 for a vehicle according to this embodiment, the larger-diameter cylinder body 22 is attached to one end portion of the smaller-diameter cylinder body 21, and the on/off valve driving solenoid 32 is provided to the other end portion thereof, whereby the center of gravity of the intermediate unit 4 can be located in proximity to the mounting bosses 25 and 26 of the smaller-diameter cylinder body 21. Accordingly, weight balancing can be readily accomplished in mounting the intermediate unit 4 to the vehicle body frame 65 so as to extend horizontally, thereby allowing the mounting bosses 25 and 26 to be reduced in size. Further, the solenoid 32 according to this embodiment is slanted with respect to the axis of the smaller-diameter cylinder body 21, whereby the size of the intermediate unit 4 as equipped with the solenoid 32 can be made compact as compared with the case where the solenoid 32 projects along the axial direction from one end portion of the smaller-diameter cylinder body 21.

It should be noted that in providing the bypass passage 52 with the throttles, in addition to the above-described arrangement, a plurality of throttles can be arranged in series in the second hydraulic fluid passage 28, or a plurality of throttles can be arranged in series between the on/off valve 30 and the first oil chamber 44. In the case where the plurality of throttles are provided in the second hydraulic fluid passage 28, they are provided on the first oil chamber 44 side (on the on/off valve 30 side) with respect to the connecting portion with the first hydraulic fluid passage 27. In this case, the second throttle 31 may be provided between the on/off valve 30 and the first oil chamber 44. Further, in providing the throttles in series, an expansion chamber with a relatively large inner diameter is provided between adjacent smaller-diameter bores of the respective throttles.

While the above-described embodiment is directed to the case where the first oil chamber 44 and second oil chamber 45 of the intermediate unit 4 are connected to the respective lower oil chambers 8 of the hydraulic shock absorbers 2 and 3, the first and second oil chambers 44 and 45 can be connected to the respective upper oil chambers 7 of the hydraulic shock absorbers 2 and 3. While in the above-described embodiment the hydraulic shock absorber system 1 is constructed such that changes in the volumes of the first and second oil chambers 44 and 45 coincide with each other at all times, the changes in the volumes of these chambers can be set to be at a fixed ratio at all times depending on the characteristics of hydraulic shock absorbers on the wheel side.

Further, other than being connected to the right and left hydraulic shock absorbers 2 and 3, the first and second oil chambers 44 and 45 can be connected to front-wheel hydraulic shock absorbers and rear-wheel hydraulic shock absorbers that are located on one side with respect to the lateral direction of the vehicle body. Alternatively, as shown in FIG. 9, the first and second oil chambers 44 and 45 can be connected to front-wheel hydraulic shock absorbers 2a and rear-wheel hydraulic shock absorbers 3a that are located on one and the other sides with respect to the lateral direction, respectively. In the example shown in FIG. 9, two hydraulic shock absorber systems 1 are used. The respective intermediate units 4 of the two hydraulic shock absorber systems 1 are mounted at positions located on the longitudinally central portion of the vehicle body and on the opposite side portions with respect to the vehicle width direction in the state where the axes thereof are oriented in the longitudinal direction and the solenoid 32 is oriented diagonally upward and frontward as shown in FIG. 4.

Further, in addition to be effected by means of a switch operated by the occupant, the switching between the energized and non-energized states of the on/off valve driving solenoid 32 may also be effected automatically according to the traveling condition or riding state of the occupant.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A hydraulic shock absorber system for a vehicle, the system comprising an intermediate unit,
the intermediate unit fluidly connecting a first shock absorber and a second shock absorber, the intermediate unit comprising a smaller-diameter cylinder body and a larger-diameter cylinder body,
the smaller-diameter cylinder body comprising a bore and the larger-diameter cylinder body comprising a bore, the smaller-diameter cylinder body and the larger-diameter cylinder body being connected to each other with the smaller-diameter cylinder body bore and the larger-diameter cylinder body bore being generally coaxial,
a smaller-diameter piston being positioned within the smaller-diameter cylinder body bore and a larger-diameter piston being positioned within the larger-diameter cylinder body bore, the smaller-diameter piston and the larger-diameter piston being integrally formed to define a free piston,
a first oil chamber being defined to a first side of the smaller-diameter piston, a second oil chamber being defined between the smaller-diameter piston and the larger-diameter piston, and a high pressure gas chamber being defined to a second side of the larger-diameter piston, the first oil chamber communicating with an oil chamber of the first shock absorber and the second oil chamber communicating with an oil chamber of the second shock absorber,
a passage connecting the first oil chamber and the second oil chamber, the passage extending through the smaller-diameter piston, a throttle being positioned to affect flow through the passage, a bypass passage also extending between the first oil chamber and the second oil chamber, the bypass passage being defined within the smaller-diameter cylinder body,
an on/off valve and a throttle are provided in series along the bypass passage, the on/off valve being opened and closed by a solenoid, the solenoid connected to the smaller-diameter cylinder body at a solenoid mounting portion, a hydraulic oil pipe connecting the first oil chamber and the second oil chamber to the first and second shock absorbers, the hydraulic oil pipe being connected to the smaller-diameter cylinder body at a hydraulic oil pipe mounting portion, and the smaller-diameter cylinder body comprising a mounting boss adapted to secure the unit on a vehicle frame side.

2. The hydraulic shock absorber system for a vehicle according to claim 1, wherein a plurality of the throttles are provided in series in the bypass passage.

3. The hydraulic shock absorber system for a vehicle according to claim 1, wherein the throttle is formed by a hole that is opened and closed by a valve member of the on/off valve.

4. The hydraulic shock absorber system for a vehicle according to claim 1, wherein the solenoid mounting portion protrudes from the smaller-diameter cylinder body in a shape of a bottomed cylinder, and the solenoid mounting portion also comprising a valve seat and a throttle that are provided on a bottom wall thereof, and one end portion of the solenoid is mounted to the solenoid mounting portion.

5. The hydraulic shock absorber system for a vehicle according to claim 1, wherein the solenoid is slanted with respect to an axis of the smaller-diameter cylinder body.

6. The hydraulic shock absorber system for a vehicle according to claim 1, wherein the smaller-diameter cylinder body is formed by a casting mold that is subjected to mold release in a radial direction thereof along a parting plane of the casting mold, and the solenoid mounting portion, the hydraulic oil pipe mounting portion, and the boss being arranged along the parting plane.
